(19) United States
(12) Patent Application Publication
(10) Pub. No.: US 2013/0298380 A1
(43) Pub. Date: Nov. 14, 2013

(54) METHOD OF MANUFACTURING PHOTONIC BANDGAP FIBER

(71) Applicant: Furukawa Electric Co., Ltd, Tokyo (JP)

(72) Inventor: Kazunori MUKASA, Tokyo (JP)

(21) Appl. No.: 13/942,105

(22) Filed: Jul. 15, 2013

Related U.S. Application Data
(63) Continuation of application No. PCT/JP2012/072638, filed on Sep. 5, 2012.

(30) Foreign Application Priority Data
Dec. 16, 2011 (JP) 2011-276125

(51) Int. Cl. H04B 10/00

(52) U.S. Cl. CPC H04B 10/12
USPC 29/428

(57) ABSTRACT

A method of manufacturing a photonic bandgap fiber, which includes: a core portion; and a cladding portion that is formed around the core portion and has holes arranged to form a photonic crystal in which the core portion is a crystal defect, includes: forming a preform by inserting, into a jacket tube, hexagonal capillary tubes having tube-holes shapes and outer shapes that are both approximately hexagonal; and drawing the preform.

### CROSS-REFERENCE TO RELATED APPLICATIONS

This application is a continuation of PCT International Application No. PCT/JP2012/072638 filed on Sep. 5, 2012 which claims the benefit of priority from Japanese Patent Application No. 2011-276125 filed on Dec. 16, 2011. The entire contents of the PCT international application and the Japanese patent application are incorporated herein by reference.

### BACKGROUND OF THE INVENTION

1. Field of the Invention

The present disclosure relates to a method of manufacturing a photonic bandgap fiber.

2. Description of the Related Art

A photonic bandgap fiber (PBGF) is an optical fiber in which holes are arranged in a cladding portion so as to form a photonic crystal. In the photonic bandgap fiber, a photonic bandgap due to two-dimensional Bragg reflection at a wavelength of light to be transmitted is formed by the arranged holes and a core portion as a crystal defect is introduced therein, to realize optical transmission.

For example, K. Saitoh, et al., OPTICS EXPRESS, Vol. 11, No. 23, 2003, pp 3100-3109 (hereinafter, Non Patent Literature 1); M. N. Petrovich et al., OFC2008, OThR4 (hereinafter, Non Patent Literature 2); and Kazunori Mukasa, et al., The Institute of Electronics, Information and Communication Engineers 2007, General Conference C-3-52 (hereinafter, Non Patent Literature 3) disclose an air-core photonic bandgap fiber whose core portion is a hole. The air-core photonic bandgap fiber is able to achieve low bending loss by very strong optical confinement with an effective area (Aeff) being enlarged to achieve ultralow non-linearity. The air-core photonic bandgap fiber thus has attracted attention for its application to communication and non-communication fields. Non Patent Literature 1 discloses a calculation method of optimizing design of profile parameters of a photonic bandgap fiber in detail.

### SUMMARY

### Technical Problem

A so-called stack and draw method is used in general to manufacture a photonic bandgap fiber, the method in which circular capillary tubes having inner and outer shapes that are both circular are prepared, inserted and stacked in a circular jacket tube having inner and outer shapes that are both circular to form a preform, and the preform is drawn.

However, when a photonic bandgap fiber is manufactured by the conventional stack and draw method using the circular capillary tubes and the circular jacket tube to satisfy profile parameters (design parameters) calculated in order to achieve certain optical characteristics, there is a problem that the optical characteristics of the photonic bandgap fiber may differ from their designed values.

Accordingly, there is a need to provide a method of manufacturing a photonic bandgap fiber, the method being able to more infallibly manufacture a photonic bandgap fiber having desired optical characteristics.

### SUMMARY OF THE INVENTION

According to an aspect of the present disclosure, a method of manufacturing a photonic bandgap fiber, which includes: a core portion; and a cladding portion that is formed around the core portion and has holes arranged to form a photonic crystal in which the core portion is a crystal defect, includes: forming a preform by inserting, into a jacket tube, hexagonal capillary tubes having tube- holes shapes and outer shapes that are both approximately hexagonal; and drawing the preform.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic sectional view illustrating an example of a photonic bandgap fiber;

FIG. 2 is a diagram illustrating an example of a calculated field distribution of a photonic bandgap fiber;

FIG. 3 is a diagram illustrating calculated wavelength characteristics of confinement loss;

FIG. 4 is a schematic sectional view illustrating a preform to be used in a manufacturing method according to a first embodiment;

FIG. 5 is a schematic sectional view illustrating a preform to be used in a manufacturing method according to a second embodiment;

FIG. 6 is a schematic sectional view illustrating a preform to be used in a manufacturing method according to a third embodiment;

FIG. 7 is a schematic sectional view illustrating a preform to be used in a manufacturing method according to a fourth embodiment;

FIG. 8 is a partial enlarged schematic sectional view illustrating a preform to be used in a manufacturing method according to a fifth embodiment;

FIG. 9 is a schematic sectional view illustrating a preform to be used in a conventional manufacturing method; and

FIG. 10 is a schematic sectional view illustrating a photonic bandgap fiber manufactured by a conventional manufacturing method.

### DETAILED DESCRIPTION OF THE PREFERRED EMBODIMENTS

Hereinafter, embodiments of a method of manufacturing a photonic bandgap fiber according to the present invention are described in detail with reference to the drawings. The invention is not limited by the embodiments. The photonic bandgap fiber is hereinafter referred to as the PBGF as appropriate.

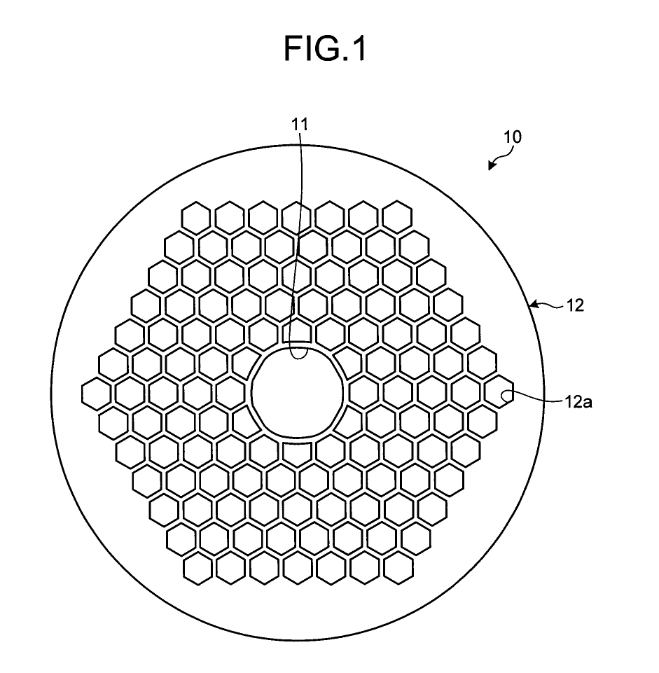

FIG. 1 is a schematic sectional view illustrating an example of a PBGF. As illustrated in FIG. 1, this PBGF 10 includes: a core portion 11 having a hole; and a cladding portion 12 formed around the core portion 11 and including holes 12a arranged regularly. For example, the cladding portion 12 is made of a silica-based glass, and in particular, preferably made of a pure silica glass containing no dopant for adjusting its refractive index.

This PBGF 10 has a structure in which the holes 12a are arranged in a triangular lattice form so as to form a photonic crystal for forming a photonic bandgap at a desired wavelength, and a region in which the one hole 12a at the center of the triangular lattice and the six holes 12a therearound are to be arranged is substituted with a hole to become the core portion 11 as a crystal defect. This PBGF 10 transmits light strongly confined to the core portion 11 with the above-mentioned structure. Such a structure in which the region of the seven holes has been substituted with the core portion is sometimes called a 7-cell PBGF. Further, a structure in which a region of twelve holes around these seven holes, that is, a region of these nineteen holes in total has been substituted with a core portion is sometimes called a 19-cell PBGF. The 7-cell PBGF is preferable since it operates on a single mode more easily (see Non Patent Literature 2).

The PBGF 10 illustrated in FIG. 1 has five hexagonal layers formed of the holes 12a surrounding the core portion 11. A ratio d/Λ, where d is a diameter (hereinafter, referred to as hole diameter) of a hole of each hole 12a and Λ is a distance (hereinafter, referred to as distance between holes) between centers of adjacent holes 12a, is set to 0.9 or greater, for example, to 0.97. As disclosed in Non Patent Literature 1, preferably the number of hole layers is set to five or greater and the ratio d/Λ to 0.9 or greater, because confinement loss is thereby reduced. The 7-cell PBGF has a core diameter of approximately 2Λ, which is twice the distance between holes. The 19-cell PBGF has a core diameter of approximately 3Λ.

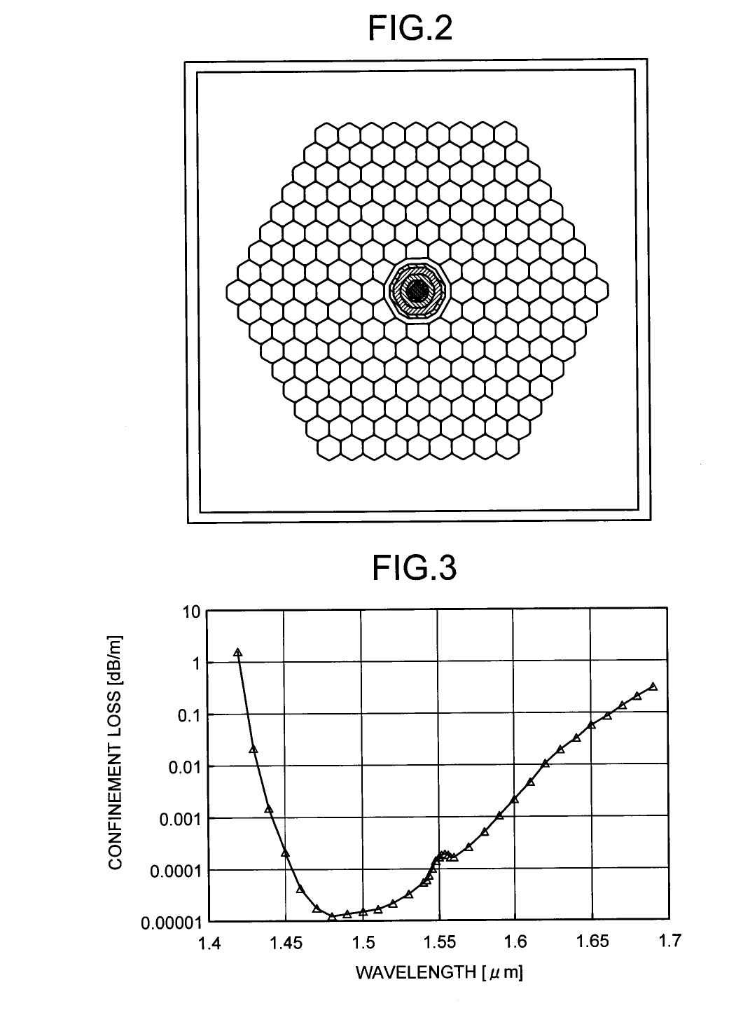

FIG. 2 is a diagram illustrating an example of a calculated field distribution of a PBGF. FIG. 3 is a diagram illustrating calculated wavelength characteristics of confinement loss of the PBGF. In FIGS. 2 and 3, simulation calculation by a finite element method (FEM) is used. A constituent material of the PBGF is pure silica glass. The ratio d/Λ is set to 0.97 and Λ to 4.05 μm. This value of 4.05 μm is a value reported by Non Patent Literature 3 to be a value at which a photonic bandgap is able to be formed at a wavelength band of 1.5 μm used in optical communications.

In this simulation, the holes had the following shapes. The core portion was octagon shaped with roundness added to each apex thereof. As for a total of twelve holes immediately therearound, pentagons and hexagons with roundness added to each apex thereof were arranged alternately. As for further holes therearound, hexagons with roundness added to each apex thereof were arranged to place seven layers of holes around the core portion. A diameter of an approximate circle on a hole of each shape was set as the hole diameter d, and a distance between centers of gravity of the hexagonal shape or the pentagonal shape of adjacent holes was set as the distance between holes Λ. As described, in the simulation in FIG. 2 and FIG. 3, each hole was assumed to be a pentagon or hexagon.

As illustrated in FIG. 2, in the PBGF calculated by setting the structure as described above, because the holes were set to be pentagon-shaped or hexagon-shaped, most of a light field was confined to the core portion at the center thereof. As illustrated in FIG. 3, confinement loss with respect to wavelength λ had a low value of 0.00001 dB/m (0.01 dB/km) at a wavelength of around 1.5 μm and a photonic bandgap was confirmed to be formed.

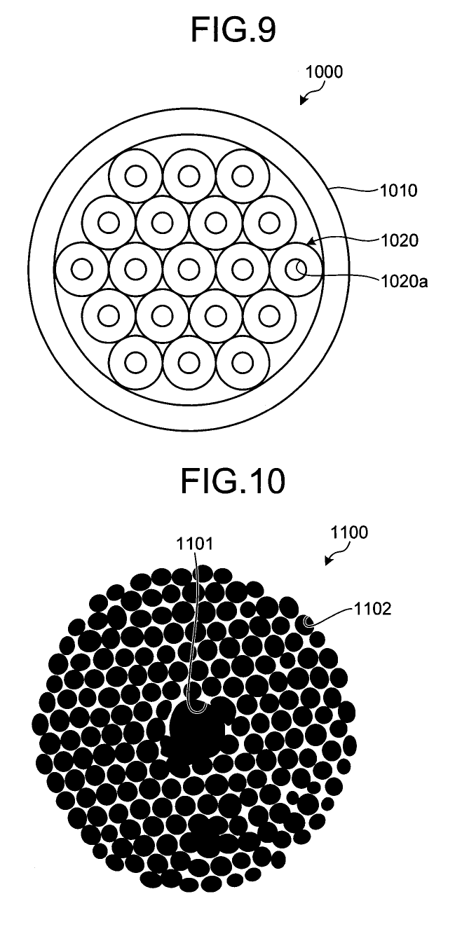

When such a PBGF is manufactured, conventionally, as illustrated in FIG. 9, circular capillary tubes 1020 with circular tube-holes 1020a and circular outer shapes are inserted and stacked in a jacket tube 1010, the capillary tubes 1020 in a region to be the core portion are thereafter pulled out to form a preform 1000, and this preform 1000 is drawn.

However, when the preform 1000 is constituted using the circular capillary tubes 1020 like this, the percentage of spaces among the capillary tubes in a cross-sectional area of the preform 1000 becomes high, and thus the capillary tubes 1020 become easily deformable upon the drawing and deformation of the hole structure becomes greater. Because optical characteristics of a PBGF are largely influenced by the hole structure of the cross-section, the optical characteristics of the PBGF manufactured by the conventional method sometimes differ from desired optical characteristics.

For example, FIG. 10 is a schematic sectional view of a PBGF manufactured by a conventional manufacturing method. As illustrated in FIG. 10, a PBGF 1100 manufactured has, in contrast to an ideal shape in which hexagonal holes are arranged in a lattice, holes 1102 that are distorted, and a shape of a core portion 1101 is also distorted. As a result, glass among the holes may become uneven with thin portions and thick portions. By such structural disorder in a cross section, transmission loss of a PBGF may become as large as a few ten to a few hundred dB/km.

Further, Japanese Patent Application Laid-open Nos. 2002-55242 and 2002-97034 disclose a method using capillary tubes having hexagonal outer shapes. However, when the capillary tubes having the hexagonal outer shapes are used, it is difficult to obtain d/Λ of a preferable value, which is 0.9 or greater, at which confinement loss is reduced sufficiently, even if deformation of the holes are suppressed.

In contrast, in a manufacturing method according to a first embodiment described below, because hollow capillary tubes with hexagonally-shaped tube-holes and hexagonal outer shapes are inserted in a hollow jacket tube to form a preform, and this preform is drawn, suppression of deformation of the holes and formation of desired d/Λ are realized simultaneously. As a result, a PBGF having desired optical characteristics are able to be manufactured more infallibly.

### First Embodiment

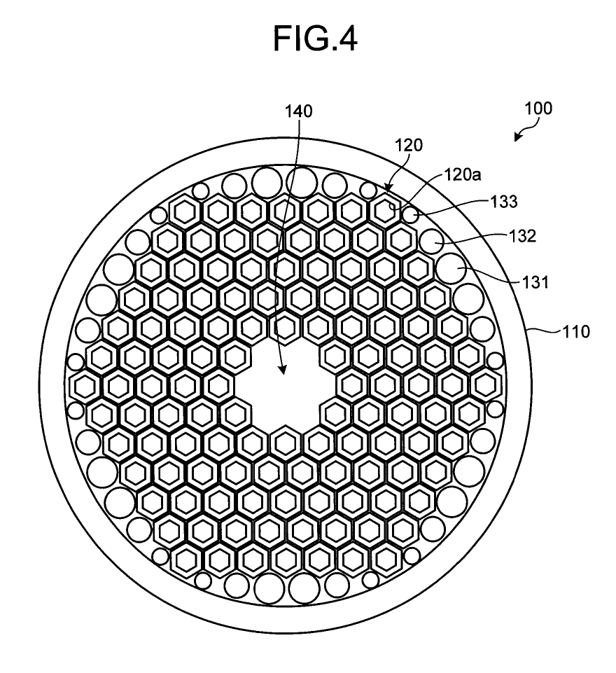

FIG. 4 is a schematic sectional view of a preform used in a manufacturing method according to a first embodiment. As illustrated in FIG. 4, a preform 100 is formed using hexagonal capillary tubes 120 with hexagonal tube-holes 120a and hexagonal outer shapes. Specifically, the preform 100 is formed by inserting and stacking the hexagonal capillary tubes 120 in a circular jacket tube 110, and thereafter pulling out the hexagonal capillary tubes 120 in a region to be a core portion to form a core forming portion 140. In forming the preform 100, rod bodies 131 to 133 for adjusting spaces are inserted into a space between the jacket tube 110 and the hexagonal capillary tubes 120. The rod bodies 131 to 133 are circular and have diameters to fit to a volume of the space. The rod bodies 131 to 133 are preferably solid but may be hollow.

The jacket tube 110, the hexagonal capillary tubes 120, and the rod bodies 131 to 133 are made of silica-based glass, for example, and in particular, are preferably made of pure silica glass containing no dopant for adjusting a refractive index. The outer shapes of the hexagonal capillary tubes 120 and the shapes of the tube-holes 120a are preferably regular hexagons, but may be approximate regular hexagons, and may be of shapes, for example, with rounded apexes.

Next, this preform 100 is drawn by a known method. Upon the drawing, the preform 100, whose lower end has been molten and collapsed to be sealed, is installed in a known drawing furnace. A gas pressurizing device is then connected to an upper end of the preform 100. Subsequently, the lower end of the preform 100 is heated and molten by a heater and the PBGF 10 is drawn. Upon the drawing, insides of the tube-holes 120a of the hexagonal capillary tubes 120 are pressurized by the gas pressurizing device so that the holes are not collapsed. The use of the preform 100 suppresses deformation of the holes (tube-holes 120a and holes 12a formed by the tube-holes 120a) upon the drawing and makes obtainment of a preferable value of d/Λ, which is 0.9 or greater, easy. Accordingly, the PBGF 10 having preferable values of confinement loss and other optical characteristics is able to be manufactured more infallibly.

### Second Embodiment

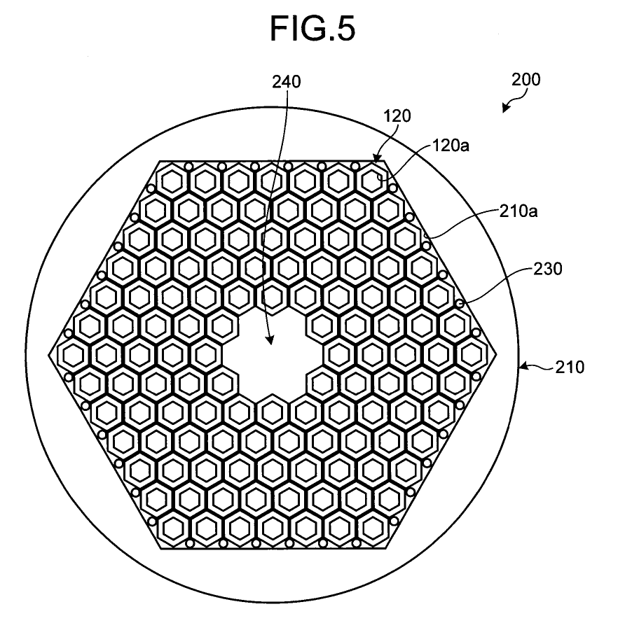

FIG. 5 is a schematic sectional view illustrating a preform to be used in a manufacturing method according to a second embodiment. As illustrated in FIG. 5, a preform 200 is formed using a jacket tube 210 with a tube-hole 210a of a hexagonal shape and a circular outer shape. Specifically, the preform 200 is formed by inserting and stacking the hexagonal capillary tubes 120 like those in FIG. 4 in the jacket tube 210, and thereafter pulling out the hexagonal capillary tubes 120 in a region to become a core portion to form a core forming portion 240. In forming the preform 200, rod bodies 230 for adjusting spaces are inserted into a space between the jacket tube 210 and the hexagonal capillary tubes 120. The rod bodies 230 are circular and have diameters fitted to a volume of the space. The rod bodies 230 are preferably solid but may be hollow. The jacket tube 210 and the rod bodies 230 are made of a silica-based glass for example, and in particular, are preferably made of a pure silica glass containing no dopant for adjusting a refractive index.

Next, by drawing the preform 200 by a known method, deformation of the holes is suppressed, and obtainment of a preferable value of d/Λ, which is 0.9 or greater, is easy. Accordingly, the PBGF 10 having preferable values of confinement loss and other optical characteristics is able to be infallibly manufactured.

In particular, in the second embodiment, the use of the jacket tube 210 having the tube-hole 210a of a hexagonal shape further decreases the space between the jacket tube 210 and the hexagonal capillary tubes 120. As a result, deformation of the holes is further suppressed. Further, diameters of the rod bodies 230 for adjusting spaces is able to be made smaller, and thus cost of materials for the rod bodies 230 is able to be reduced. When inner diameters of the hexagonal capillary tubes 120 are relatively smaller than an inner diameter of the jacket tube 210, the rod bodies 230 may not be used as appropriate.

### Third Embodiment

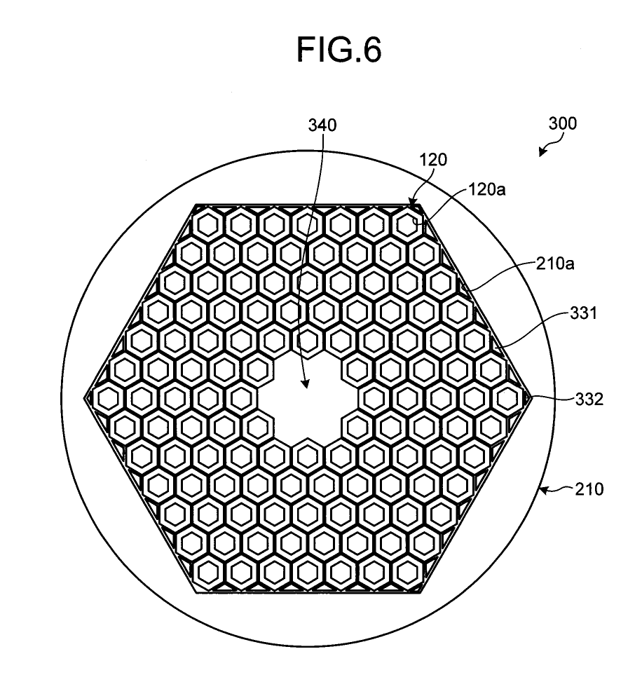

FIG. 6 is a schematic sectional view illustrating a preform to be used in a manufacturing method according to a third embodiment. As illustrated in FIG. 6, a preform 300 is formed by, like the preform 200 according to the second embodiment, inserting and stacking the hexagonal capillary tubes 120 in the jacket tube 210 having the tube-hole 210a of a hexagon, and thereafter forming a core forming portion 340. However, in the preform 300, rod bodies 331 and 332 for adjusting spaces are inserted into a space between the jacket tube 210 and the hexagonal capillary tubes 120. The rod bodies 331 and 332 are triangular-shaped and have a larger effect of filling the space than the rod bodies 230 in the second embodiment. Therefore, deformation of the holes upon the drawing is able to be suppressed even further. Rod bodies of a polygonal shape other than the triangular shapes may be used.

### Fourth Embodiment

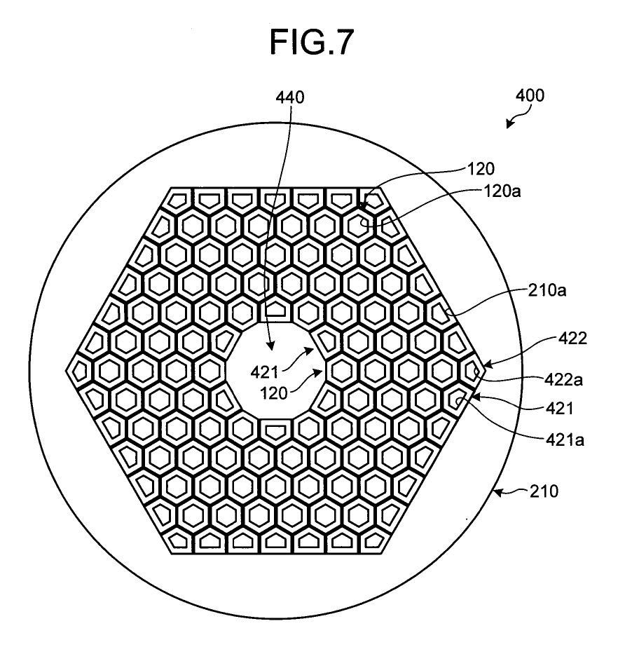

FIG. 7 is a schematic sectional view illustrating a preform to be used in a manufacturing method according to a fourth embodiment. As illustrated in FIG. 7, a preform 400 is formed by, like the preform 200 according to the second embodiment, inserting and stacking the hexagonal capillary tubes 120 in the jacket tube 210 having the tube-hole 210a of a hexagon, and thereafter forming a core forming portion 440. However, in the preform 400, pentagonal capillary tubes 421 and 422, which are hollow and have tube-holes 421a and 422a each approximately pentagon-shaped and outer shapes each of an approximate pentagon, are inserted along an inner wall of the jacket tube 210. Accordingly, most of the space between the pentagonal capillary tubes 421 and 422 and the jacket tube 210 is eliminated, and thus deformation of the holes upon the drawing is further suppressible. Further, rod bodies for adjusting spaces do not need to be used and thus cost for their materials is reducible.

In the preform 400, the pentagonal capillary tubes 421 are also inserted to be positioned at a periphery of the core forming portion 440. Accordingly, at the periphery of the core forming portion 440, the hexagonal capillary tubes 120 and the pentagonal capillary tubes 421 are arranged alternately. Thereby, deformation of the core portion 11 of the PBGF 10 manufactured is suppressed even further.

### Fifth Embodiment

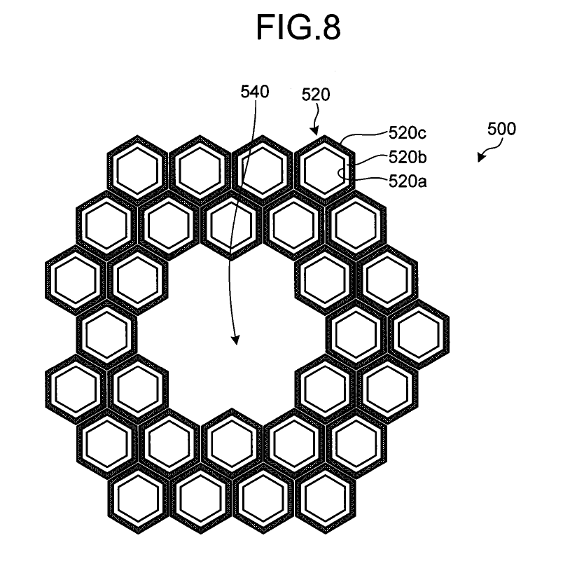

FIG. 8 is a partial enlarged schematic sectional view illustrating a preform used in a manufacturing method according to a fifth embodiment. In a preform 500 according to the fifth embodiment, hexagonal capillary tubes 520 are used as the hexagonal capillary tubes to be inserted into the jacket tube, each hexagonal capillary tube 520 including a tube-hole 520a of a hexagonal shape, an inner peripheral portion 520b, and an outer peripheral portion 520c formed on a periphery of the inner peripheral portion 520b. Reference numeral 540 denotes a core forming portion.

The outer peripheral portions 520c of the hexagonal capillary tubes 520 are made of a material having a viscosity lower than that of the inner peripheral portions 520b. For example, the inner peripheral portions 520b are made of pure silica glass and the outer peripheral portions 520c are made of a silica glass added with chlorine, fluorine, or germanium.

When this preform 500 is drawn, due to heating in the drawing, the outer peripheral portion 520c of each hexagonal capillary tube 520 is molten first and integrated with the outer peripheral portions 520c of its surrounding hexagonal capillary tubes 520, and thus a space originally present among the hexagonal capillary tubes 520 is filled. The inner peripheral portions 520b are harder to be molten than the outer peripheral portions 520c, and thus has a higher effect of maintaining the shapes of the tube-holes 520a.

Therefore, when this preform 500 is used, due to the effect of filling in the space early by the melting of the outer peripheral portions 520c and the effect of the inner peripheral portions 520b maintaining the shapes of the holes, deformation of the holes is suppressed even further.

According to an embodiment of the disclosure, a photonic bandgap fiber having desired optical characteristics is able to be manufactured more infallibly.

The present invention is not limited by the above-mentioned embodiments. For example, the PBGF is of the 7-cell type in the above-mentioned embodiments, but it may be that of the 19-cell PBGF type or a PBGF including a core portion of another structure. Further, the arrangement of the holes is not limited to the triangular lattice form and may be of any arrangement that is able to form a photonic bandgap.

PBGFs constituted by combining any of the above-mentioned components as appropriate are included in the present invention. For example, in the first embodiment, the pentagonal capillary tubes may be arranged around the core forming portion as in the fourth embodiment, or the hexagonal capillary tubes having the inner peripheral portions and the outer peripheral portions as in the fifth embodiment may be used. Further, in the fourth embodiment, pentagonal capillary tubes including inner peripheral portions and outer peripheral portions having a viscosity lower than that of the inner peripheral portions may be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a photonic bandgap fiber including: a core portion; and a cladding portion that is formed around the core portion and has holes arranged to form a photonic crystal in which the core portion is a crystal defect, the method comprising:
forming a preform by inserting, into a jacket tube, hexagonal capillary tubes having tube-holes shapes and outer shapes that are both approximately hexagonal; and
drawing the preform.

2. The method of manufacturing the photonic bandgap fiber according to claim 1, wherein rod bodies for adjusting spaces are inserted between the jacket tube and the hexagonal capillary tubes in the forming.

3. The method of manufacturing the photonic bandgap fiber according to claim 2, wherein the rod bodies having outer shapes that are approximately polygonal are used in the forming.

4. The method of manufacturing the photonic bandgap fiber according to claim 1, wherein the jacket tube having a tube-hole shape that is approximately hexagonal is used in the forming.

5. The method of manufacturing the photonic bandgap fiber according to claim 4, wherein pentagonal capillary tubes having tube-hole shapes and outer shapes that are both approximately pentagonal are inserted along an inner wall of the jacket tube in the forming.

6. The method of manufacturing the photonic bandgap fiber according to claim 1, wherein, in the forming, pentagonal capillary tubes having tube-hole shapes and outer shapes that are both approximately pentagonal are inserted to be positioned at a periphery of a core forming portion for forming the core portion.

7. The method of manufacturing the photonic bandgap fiber according to claim 1, wherein capillary tubes including inner peripheral portions and outer peripheral portions that are formed around the inner peripheral portions and have a viscosity lower than that of the inner peripheral portions are used as the pentagonal capillary tubes or the hexagonal capillary tubes in the forming.

8. The method of manufacturing the photonic bandgap fiber according to claim 1, wherein, in the forming, the pentagonal capillary tubes or the hexagonal capillary tubes are inserted such that the number of layers of holes surrounding the core portion becomes equal to or greater than five.
